(19) United States
(12) Patent Application Publication
(10) Pub. No.: US 2026/0091551 A1
(43) Pub. Date: Apr. 2, 2026

(54) METHOD AND 3D PRINTING DEVICE FOR THE ADDITIVE MANUFACTURING OF MULTIPLE COMPONENTS BY ADJUSTING THE PRINTING PATH OF A PRINTHEAD

(71) Applicant: NEW AIM3D GMBH, Rostock (DE)

(72) Inventors: Clemens Lieberwirth, Rostock (DE); Vincent Morrison, Krakow am See (DE)

(21) Appl. No.: 19/137,760

(22) PCT Filed: Nov. 16, 2023
(86) PCT No.: PCT/EP2023/082058

§ 371 Date: Dec. 18, 2025

(30) Foreign Application Priority Data
Dec. 13, 2022 (DE) 10 2022 133 116.4

(51) Int. Cl. B29C 64/182; B29C 64/209; B29C 64/321; B29C 64/393; B33Y 10/00; B33Y 30/00; B33Y 50/02

(52) U.S. Cl. CPC B29C 64/182; B29C 64/209; B29C 64/321; B29C 64/393; B33Y 10/00; B33Y 30/00; B33Y 50/02

(57) ABSTRACT

Provided is a method for the additive manufacturing of multiple components by utilizing at least one print head of a 3D printing device, wherein the components are manufactured layer by layer and successively along an axis on a printing platform. It is provided that in a layer plane for each of the components succeeding each other along the axis an outer contour initially is manufactured via the at least one print head, which borders a filling region for the respective component. Subsequently the at least one print head is adjusted along the axis in order to introduce printing material into the filling regions of the multiple components successively along a first printing path, before the print head again is adjusted along the axis in order to introduce printing material into the filling regions of the multiple components successively along a second printing path offset from the first printing path.

The proposed solution in particular relates to a method for manufacturing multiple components and utilizing at least one print head of a 3D printing device.

Through the additive manufacturing of a component by means of a 3D printing device a component is built up layer by layer. Via at least one extruder and here in particular at least one extruder screw provided within the extruder, metal granulate, ceramic granulate and/or plastic granulate then for example is molten and conveyed to a print head of the extruder in order to therefrom build up a component layer by layer. In practice, full-body sections of the component to be manufactured usually have so far been produced in 3D printing by a full-surface application of printing material in the respective component layer. For this purpose, the corresponding surface is completely scanned by means of the print head in the component layer, while printing material is deployed continuously.

For example, when manufacturing multiple components on a printing platform it is common practice that a component layer of one of the components to be manufactured is finished completely before the print head begins with the manufacture of a component layer of another component. As the print head possibly must be adjusted along several printing paths when preparing a component layer and subsequently is adjusted to another region of the printing platform, on which printing material in turn is deployed along several printing paths, the print head is accelerated and slowed down repeatedly. Hence, when manufacturing multiple components on a printing platform in an additive manufacturing process a comparatively large number of braking and accelerating operations must be performed. At the same time, it always is necessary to accelerate additive manufacturing processes.

Hence, there is a need of improved printing strategies for 3D printing and hence of methods with which an additive manufacture of multiple components on a printing platform can be accelerated.

This is remedied by the proposed solution according to independent claims 1 and 11.

In a proposed method for the additive manufacturing of multiple (at least two) components by utilizing at least one print head of a 3D printing device it is proposed that
in a layer plane for each of the successive components along a (printing) axis to be built up layer by layer an outer contour initially is manufactured via the at least one print head, which borders a filling region for the respective component, and
subsequently the at least one print head is adjusted along the axis in order to introduce printing material into the filling regions of the multiple components successively along a first printing path, before the print head again is adjusted along the axis in order to successively introduce printing material into the filling regions of the multiple components along a second printing path offset from the first printing path.

The proposed solution thus proceeds from the basic idea, when multiple components are to be manufactured on a printing platform along a (printing) axis, to initially form the desired outer contour in a layer plane for each component, before a filling of the components is printed printing path by printing path and hence vector by vector or line by line across all components. Thus, for each component layer of a component the outer contour first is printed, before subsequently filling regions of the components (possibly completely) bordered with the outer contours are successively provided with printing material by the at least one print head adjusted along a printing path. The component layer in a filling region of a component thus is manufactured with printing material which is deployed during an adjustment of the print head along several printing paths. During the adjustment along a printing path, the print head crosses several regions on the printing platform on which components are to be manufactured. Via the print head, a component layer of exactly one component correspondingly is not formed completely in a layer plane—as has frequently been the case so far in practice-in the respective filling region, before in the corresponding layer plane the component layer is formed completely for a further component in its filling region.

During an additive manufacture according to the proposed solution, printing material rather is deployed successively along a printing path for all components which are to be manufactured one beside the other along the printing path, or—from the point of view of the software generating (control) commands for the 3D printing device for manufacturing the components—lie one beside the other. Thus, a deployment of printing material across all components is effected. In this way, for example, one component layer each for the multiple components can be manufactured by means of at least one extruder including the print head in that
in a first working step outer contours for the components to be manufactured initially are produced in the respective component layer, which each extend in the layer plane and each comprise at least one outer wall extending in a direction of extension perpendicular to the layer plane for at least partly bordering the filling region, so that within a filling region at least one volume chamber open in the direction of extension is formed, and
in a succeeding, second working step printing material is introduced into the filling regions of the components (in particular of all components along the axis) along the first printing path, before in a further succeeding, third working step printing material is introduced into the filling regions of the components along the second printing path.

Here, it can of course be provided that for a predetermined configuration of a filling region the print head also must be guided over a filling region more than twice and hence along more than two printing paths, in order to apply sufficient printing material in a component layer.

The proposed solution in particular offers the advantage that during an adjusting movement along a printing path a print head deploys printing material for multiple components, before a change of the printing path is effected, whereby the number of braking and accelerating operations in part can be reduced considerably as compared to 3D printing methods commonly used in practice. This in turn involves a significant reduction of the manufacturing time. In other words, in a manufacturing process on a printing platform a defined number of components can at the same time be manufactured in a shorter time.

In one embodiment, the at least one print head is adjusted along the (adjustment) axis during the adjustment along the first printing path in a first adjustment direction, while during an adjustment along the second printing path the print head is adjusted in a second adjustment direction opposite to the first adjustment direction along the printing axis.

In principle, it can be provided that at the end of an adjusting movement along one of the printing paths the print head carries out a turning and/or transverse movement in such a way that during a subsequent adjusting movement the print head is adjusted along a succeeding printing path offset in parallel from the previous printing path. At the end of an adjusting movement covering multiple components, the print head consequently is driven along a printing path to perform a turning and/or transverse movement, via which the print head is displaced such that the print head subsequently is adjusted along another printing path across the regions on the printing platform for the components to be manufactured, which extends offset in parallel from the previous printing path.

In principle, it can be provided that the print head must be first slowed down for a turning and/or transverse movement, whereby the printing time can already be further reduced. Furthermore, it can be provided that printing material is introduced into the filling regions of the multiple components in a layer plane by reciprocating the print head along mutually offset, parallel printing paths over all outer contours each for the components to be manufactured one beside the other along the axis. In connection with the manufacturing process it is, however, also possible that an adjustment axis, along which the print head switches from one printing path to a succeeding printing path, and the printing axis between two component layers alternate. For example, a component layer, based on a Cartesian coordinate system, is printed along an X-axis in multiple printing paths, which are offset along the Y-axis. At least one succeeding component layer then is printed along the Y-axis. Here, the printing paths then are offset along the X-axis.

A further reduction of the printing time can be achieved in one embodiment in which it is provided that for a change of the printing direction a turning radius is chosen for the print head in such a way that a vector speed of the print head does not change. Then, a speed component of the adjustment speed can be reduced in that spatial direction along which the print head is adjusted along the printing path, while a speed component perpendicular thereto is increased. This for example includes a variant in which, based on a Cartesian coordinate system, an adjustment speed of the print head is reduced along an X-axis, but is increased along the Y-axis, so that the print head carries out a turning movement in an XY-plane with an adjustment speed which substantially or even exactly corresponds with that adjustment speed with which previously an adjustment of the print head along a printing path has been effected along the X-axis. In particular in this context it can also be provided that a turning radius therefor is chosen so large that with the turning movement the print head initially skips at least one printing path along which the print head is then adjusted only after at least one renewed turn at the other end.

Moreover, it is quite obvious that the basic idea of the proposed solution also is realized when instead of or in addition to a power-operated adjustment of the print head relative to the printing platform (and hence e.g. relative to a print bed) a power-operated adjustment of the printing platform relative to the print head is effected, in particular in order to deploy filling material by means of the print head along the printing axis and/or to switch from one printing path to the next.

In principle, it can be provided that the multiple components are arranged along the axis in a row one beside the other or one behind the other and printing material is introduced into the filling regions of the components of the row along the first printing path, before a further introduction of printing material into the same filling regions of the components of the same row is effected along the second printing path. An adjusting movement along a printing path hence is provided for the introduction of printing material into a plurality of different filling regions. This in particular includes the fact—as already explained above—that in a filling region of one or more of the components printing material repeatedly is introduced via the traversal along several printing paths, as the component layer in the respective filling region is not yet formed completely after crossing over once and/or as previously, due to a turning radius of the print head chosen correspondingly large, one or more printing paths initially were skipped.

Alternatively or additionally, the components each are separated from each other by a gap along the axis. During an adjusting movement of the print head along a printing path, in which printing material is introduced into the filling regions of the multiple components, the deployment of printing material from the print head in one embodiment is stopped (temporarily) when crossing the gap. The widths of the gap between two adjacent components here can each be identical but can also be different. In the corresponding embodiment it merely is decisive that, e.g. controlled via an electronic control unit of the 3D printing device, the deployment of printing material from the at least one print head is stopped temporarily when the print head is located above a respective gap which is present between two adjacent components or sections of their outer contours, so that no printing material is introduced into the gap. The electronically controlled stopping of the deployment of printing material can be adjusted to the deployment of printing material and the 3D printing device in such a way that an adjustment speed of the print head along the printing path need not be changed, in particular need not be slowed down when the print head is traversed in the direction of the gap.

In a development, the print head thus can be adjusted with a constant adjustment speed along the printing path across the multiple components (or the regions provided therefor on the printing platform). The deployment of printing material then is briefly stopped merely in the gaps to be provided between the components to be manufactured. The size of the gaps between the components here can be predetermined in particular so small and be adjusted to an adjustment speed of the print head that a width of the gap just is sufficiently large that on stopping of the deployment of printing material it is ensured that no printing material will drop from the print head into the gap. For example, the print head is part of an extruder of the 3D printing device with a rotatable extruder screw via which printing material is conveyed to the print head. A width of a gap between two components then each is dimensioned such that the deployment of printing material can be stopped by stopping or turning back the extruder screw when a gap is crossed. A width of a gap here consequently is dimensioned such that a rotation of the extruder screw can be stopped when the gap is crossed, without an end of the extruder and in particular a nozzle orifice of the nozzle head having to be closed mechanically via a closure element. Of course, however, a temporary closure via a closure element also is easily conceivable. Then for example an actuator for the closure element is correspondingly actuated by the electronic control unit for closing and opening in the region of the gap.

In the present case, the adjustment speed of the print head is meant to be that speed with which the print head is adjusted along the print bed. In a 3D printing device with at least one extruder screw this typically also corresponds to the so-called printing speed. The same is to be distinguished from the build rate and hence that speed which indicates how many components are manufactured per unit time, e.g. per minute.

In principle, several rows of components or component sections can also be manufactured on the printing platform. Each row consequently includes multiple components or component sections, which are successively arranged along an axis. The components or component sections here can be manufactured row by row with their outer contours and then be provided with printing material via the adjustment of parallel printing paths within their respective outer contours, before the print head approaches a further row of components or component sections. In particular, the rows can be arranged parallel to each other so that the print head merely moves over the printing platform along printing paths parallel to each other, in order to print component layers in a layer plane vector by vector or line by line (after a formation of corresponding outer contours). With the deployment of printing material in successive layers it can also be provided that component sections of different rows are connected to each other in the further manufacturing process.

Via a printing material introduced in a respective filling region, the respective filling region in principle can at least partly be filled with printing material. This in particular means that a filling region bordered by an outer contour possibly is completely filled with printing material in a component layer. Alternatively or additionally, however, at least one inner wall, in particular a lattice structure, can also be formed within the filling region. Via at least one inner wall and in particular a lattice structure in the filling region at least one (additional) volume chamber can be formed in the filling region. A corresponding volume chamber here can remain as an air-filled cavity in the component to be manufactured. Alternatively, one or more volume chambers formed in a filling region of a component can still be filled with printing material in a succeeding working step.

In principle, a plurality of identical components can be manufactured on a printing platform with the proposed manufacturing method. Of course, however, the proposed method also is easily suitable for manufacturing different components which are to be printed on a printing platform in a manufacturing process.

At least one constituent of the printing material used for manufacturing an outer contour of a component and/or for introduction into a filling region can be a plastic material, a metal or a ceramic.

The proposed solution furthermore also relates to a 3D printing device for the additive manufacturing of multiple components on a printing platform of the 3D printing device. A proposed 3D printing device for building up the components layer by layer here comprises at least one extruder with at least one print head for deploying printing material and at least one electronic control unit controlling the extruder with at least one processor and at least one memory. The at least one memory then contains (control) commands which on execution by the at least one processor cause the extruder, during the additive manufacturing
in a layer plane for each of the successive components along an axis to be built up layer by layer to initially manufacture an outer contour via the at least one print head, which borders a filling region for the respective component, and
to subsequently adjust the at least one print head along the axis in such a way that printing material is introduced into the filling regions of the multiple components successively along a first printing path, before the print head again is adjusted along the axis in order to successively introduce printing material into the filling regions of the multiple components along a second printing path offset from the first printing path.

A proposed 3D printing device consequently is adapted to each print outer contours for the individual components in a first working step during the introduction of printing material for a layer plane of the multiple components so that a plurality of outer contours for the multiple components are present within a component layer, before subsequently the respective filling regions of the components are printed by adjusting the at least one print head printing path by printing path.

An embodiment of a proposed 3D printing device thus is suitable in particular for carrying out an embodiment of a proposed additive manufacturing method. The advantages and features of embodiments of a proposed manufacturing method as explained above and below thus also apply for embodiments of a proposed 3D printing device, and vice versa. The attached Figures by way of example illustrate possible embodiments of the proposed solution.

In the drawings:

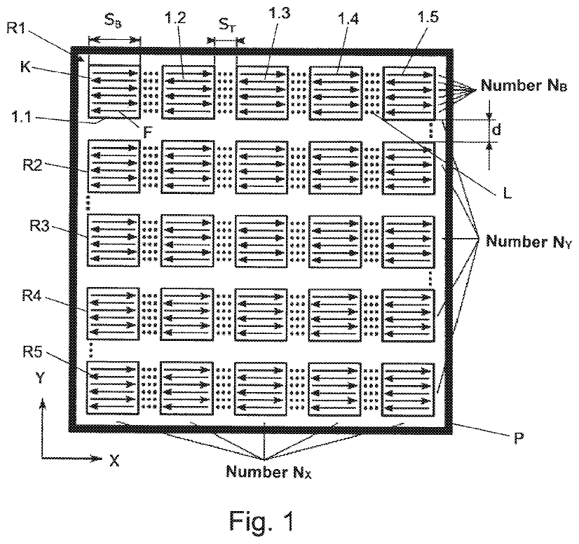

FIG. 1 schematically and in a top view shows a printing platform of an embodiment of a proposed 3D printing device, on which several rows of components are additively printed by utilizing an embodiment of a proposed manufacturing method;

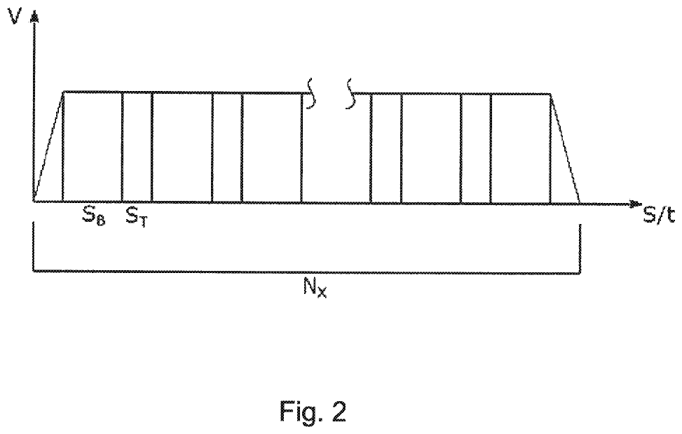

FIG. 2 shows a speed-time diagram for an adjusting movement of a print head for printing the components of FIG. 1, which the print head carries out along a printing path;

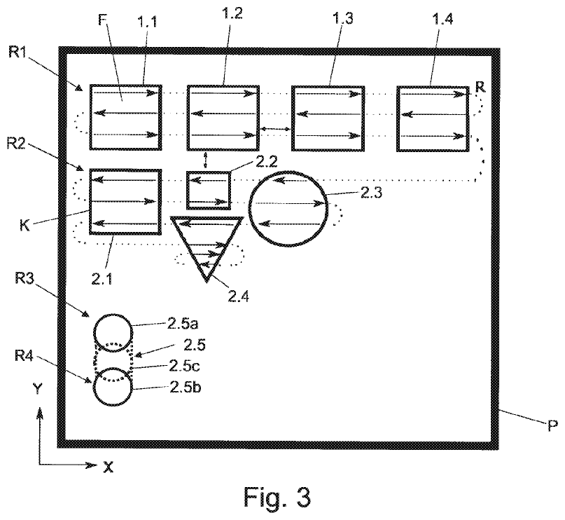

FIG. 3 likewise in a top view of the printing platform of FIG. 1 shows a representation of rows of components to be manufactured, which at least partly have geometrically different outer contours;

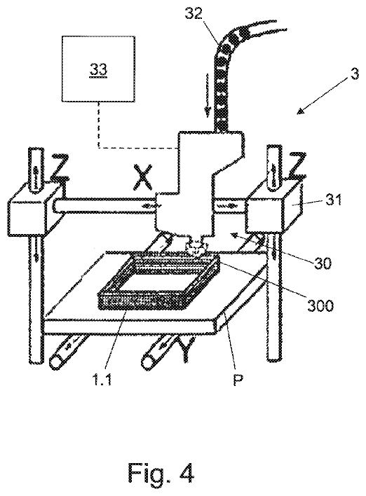

FIG. 4 in a perspective view and schematically shows a 3D printing device with the printing platform of FIGS. 1 and 3;

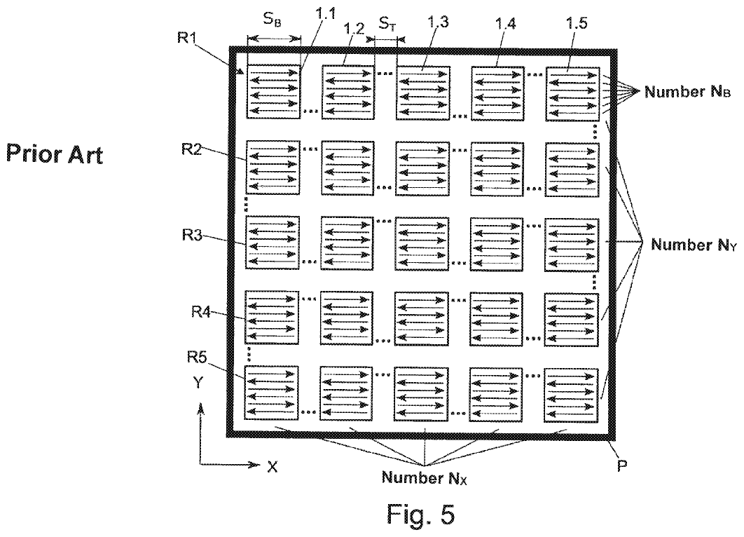

FIG. 5 shows the printing platform with an illustration of a method for the additive manufacturing of several rows of components on the printing platform, which is known from the prior art;

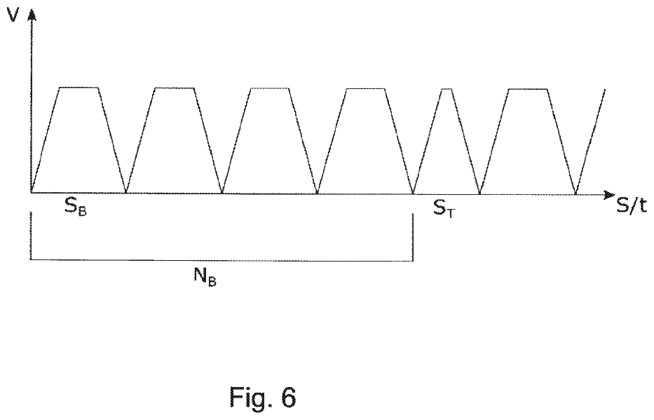

FIG. 6 shows a speed-time diagram for illustrating the accelerating and braking operations in the method for the additive manufacturing of multiple components on a printing platform, which is known from the prior art, corresponding to FIG. 5.

FIG. 4 by way of example shows a 3D printing device 3 with which an embodiment of the proposed solution can be carried out. The 3D printing device 3 includes a printing platform P for components to be manufactured additively. Above the printing platform P a printing unit or extruder 30 with a print head 300 is provided. Within the extruder 30 an extruder screw rotatable about is longitudinal axis is provided, via which molten printing material can be conveyed to the print head 300. The extruder screw here contains printing material from a material feeder 32 of the 3D printing device 3. The printing material for example can contain metal granulate, ceramic granulate and/or plastic granulate.

The extruder 30 with the print head 300 is mounted above the printing platform P so as to be adjusted by means of one or more motor drives. The extruder 30 here for example is adjustable along two mutually perpendicular spatial axes X and Z or X and Y of a Cartesian coordinate system. In addition, the printing platform P can be adjustable along a spatial axis Y or Z. The printing platform P frequently is adjustable for example along a vertical and hence along the Z-axis, while the extruder 30 with the print head 300 is adjustable in the XY-plane.

Via the 3D printing device 3 multiple components or individual components can be additively built up layer by layer and hence be printed on the printing platform P. FIG. 4 by way of example shows a component 1.1 on the printing platform P. Via an electronic control unit 33 of the 3D printing device 3 including at least one processor and at least one memory, the drives, for example electromotive, hydraulic and/or pneumatic drives of the adjustment assembly 31, are actuated so that via the printing material deployed on the print head 300 the one or more components are built up layer by layer with the intended geometry on the printing platform P. Then for example in the memory of the electronic control unit 33 control commands are provided for the adjustment of the extruder 30 with its print head 300 in order to manufacture multiple components on the printing platform P in a manufacturing process.

To provide here for an efficient manufacture of multiple components on the printing platform P corresponding to the top view of FIG. 5, it can be provided that the components to be manufactured are built up layer by layer on the printing platform P in several rows R1 to R5 parallel to each other. FIG. 5 by way of example shows a grid of 5×5 components. The individual rows R1 to R5 each include components to be manufactured one beside the other along the X-axis. Thus, for a first row R1 for example five components 1.1 to 1.5 are provided, which in the present case each-at least in the illustrated layer plane—have a rectangular outer contour. Each row R1 to R5 hence has a number N_{X}=5 of components to be manufactured. The rows R1 to R5 furthermore are oriented parallel to each other along the Y-axis. In the present case a number N_{Y}=5 of rows R1 to R5 is provided.

The components to be manufactured on the printing platform P in the present case have a (component) width S_{B} along the X-axis and are each spaced apart from each other at a distance of a gap width S_{T}. In the manufacture known from the prior art the components 1.1 to 1.5 of the first row R1 for example are built up completely one after the other component layer by component layer. In other words, a component layer for the first component 1.1 for example initially is formed completely via the print head 300 in the first row R1, before the print head 300 completely forms the component layer for the next component 1.2. For each component layer of a component of the first row R1 the print head 300 must be moved to and fro repeatedly along the X-axis, until the complete component layer for the respective component is made. In the example shown in FIG. 5, the print head 300 for example must perform a number N_{B=6} of changes in direction, in order to finish a component layer for a component within defined outer contours, before the print head then bridges the gap of the gap width S_{T} along the X-axis and continues printing of the component layer for the next component of the row.

As is illustrated with reference to the speed-time diagram of FIG. 6, the print head 300 thus must be accelerated and slowed down repeatedly in a power-operated way, in order to perform the various changes in direction. After the complete production of a component layer for one of the components, the print head 300 then must be accelerated and slowed down again for bridging the gap width S_{T}.

An embodiment of the proposed solution now chooses another approach in order to additively manufacture multiple components on a printing platform P by means of a 3D printing device 3. Corresponding to the representation of FIG. 1 it is provided to initially form the respective outer contours K for all components 1.1 to 1.5 of a row R1, which are to be manufactured along the X-axis, in a first working step via printing material deployed at the print head 300. For component layers of the components 1.1 to 1.5 of the row R1 currently to be produced the print head 300 subsequently each is traversed along parallel printing paths over all regions of the printing platform P along the X-axis, in which printing is to be continued for the components 1.1 to 1.5 through filling regions F bordered by the respective outer contour. Thus, the print head 300 for example in a second working step initially moves in the +X direction along a first printing path parallel to the X-axis (or a printing axis extending in the ±X direction), in order to introduce printing material into each filling region F for the components 1.1 to 1.5. At the end of the first printing path and hence in the present case in the region of an edge of the printing platform P, the print head 300 performs a circular arc-shaped turning movement and/or a superimposed transverse movement along the Y-axis, in order to be adjusted, in a succeeding third working step, in an opposite direction-X along a second printing path offset in parallel from the first printing path, and here in turn—but in reverse order—over all regions of the printing platform P on which the components 1.1 to 1.5 of the row R1 are to be formed. In principle, it is not excluded that an offset along the Z-axis is present between two successive printing paths. The gap width S_{T} between adjacent components of existing gaps L along the X-axis is chosen comparatively small in the present case (for example in a range of 4 to 12 mm) and adjusted to the adjustment speed of the print head 300 along the X-axis. In the present case, the extruder 30 can be switched on and off in a targeted way by means of the electronic control unit 33 so that when crossing a gap L no printing material is deployed and it is not necessary to reduce the adjustment speed of the print head 300 when traversing the gap L.

In the embodiment shown in FIG. 1, the components of different rows R1 to R5 each are spaced apart from each other at a distance d along the Y-axis. This distance d can lie in the range of the offset of the printing paths for the print head 300. For example, the distance d is greater than a distance of the printing paths among each other by at least the factor of 2 or more. Preferably, an offset between the parallel printing paths of the print head 300 in turn substantially or exactly corresponds to the width of a web of printing material to be deployed at the print head 300. For example, this offset lies in a range of 0.6 mm and the distance d lies in a range of 20 to 100 mm.

As is illustrated with reference to the speed-time diagram of FIG. 2, the print head 300 in the illustrated embodiment thereby can be traversed at a constant adjustment speed after an initial acceleration along a printing path. The deployment of printing material at the nozzle head 300 on traversal of the gaps L to be provided then always is each stopped only by stopping the rotation of the extruder screw in the extruder 30. The print head 300 must be slowed down only at the end of the row R1, in order to be adjusted in the opposite adjustment direction along a printing path offset in parallel. As compared to the manufacturing method known from the prior art, distinctly less accelerating and braking operations thus are necessary for the application of the printing material in the filling regions F of the components 1.1 to 1.5 to be manufactured as compared to the accelerating operations corresponding to FIG. 6. This leads to a significantly shorter manufacturing time. The smaller for example the component width S_{B} and/or the gap width S_{T} becomes, the larger the time saving to be achieved. The same applies for the number N_{X} of components of a row R1 to R5 or the number N_{Y} of rows. The larger the respective number of components to be manufactured, the larger the time saving becomes with the proposed solution as compared to the method outlined with FIG. 5 and known from the prior art. It can be shown for example that in the arrangement of a total of 25 components to be manufactured, which is shown in FIGS. 1 and 5, an achievable time saving is more than 25%. With N_{X}=15 and N_{Y}=15, this time saving increases to more than 50% (on the exemplary assumption of S_{B}=20 mm and S_{T}=5 mm).

The proposed solution thus creates an enormous time and cost advantage for the so-called nesting, i.e. for placing as many small components as possible on the printing platform P, which in the previously used extrusion methods is not utilized for the additive manufacture. The intended filling of the components of a row printing path by printing path or vector by vector in combination with the targeted switch-on and switch-off of the deployment of printing material on the traversing print head 300 hence makes the number of components to be manufactured on a printing platform P per unit time via a manufacturing process rise significantly.

With reference to FIG. 3 it is illustrated that in contrast to the representation in the embodiment of FIG. 1 it is not absolutely necessary in connection with the proposed method that identical components must be manufactured within a row R1 to R5. Both within a row R1 to R5 and between the rows R1 to R5 differences may exist in the components to be manufactured as regards their geometry and outer contours K and for example also in the design of their filling regions F. FIG. 3 by way of example therefor shows a combination of a first row R1 with four identical components 1.1 to 1.4 to be manufactured one beside the other along the X-axis. In a row R2 offset thereto in the-Y direction components 2.1 to 2.4 are to be manufactured on the printing platform P, which as regards their outer contours K each differ both from the components 1.1 to 1.4 and among each other. The introduction of printing material printing path by printing path into the filling regions F bordered by the respective outer contour K produced first will however be maintained here as well. Where printing material is to be introduced along a printing path of the print head 300 into a filling region F of a component 1.1-1.4, 2.1-2.4 to be manufactured, the extruder screw of the extruder 30 is driven. For the gaps between adjacent components the extruder screw is stopped, while the print head 300 is traversed further along the X-axis without changing the adjustment direction and preferably also without changing the adjustment speed.

FIG. 3 furthermore illustrates a circular turning path with a radius r, along which the print head 300 is traversed at the end of a printing path in order to realize the required offset for the succeeding printing path. The corresponding turning radius r is greater than a technically minimally realizable turning radius of the extruder 30, which for example is determined by the acceleration and the weight of the print head 300 and the realization of a possible closure at the nozzle head 300.

In rows R3 and R4 likewise shown by way of example in FIG. 3 component sections 2.5a and 2.5b of a component 2.5 can also be manufactured, which in the course of the manufacturing process are connected to each other so that the same transition into a single (here central) component section 2.5c of the component 2.5. Here, the component sections 2.5a and 2.5b of different rows consequently are connected to each other in the further manufacturing process, so that—together with the further component section 2.5c—they form the component 2.5. This component 2.5 for example is Y-shaped in cross-section and provided as a pipe fitting.

In the illustrated method it is of course not absolutely necessary either that a filling region F of each component layer is filled completely via introduced printing material. When traversing along a printing path, the print head 300 controlled by the electronic control unit 33 can of course also form one or more inner walls, in particular a lattice structure in a filling region F of a component. Hollow volume chambers thereby can be printed for example in a targeted way within a filling region F. These hollow volume chambers can remain without any further filling or be filled in part in a further working step, possibly also with another printing material.

Via the proposed solution, an improved infill strategy can be realized in particular as regards time, costs and amount of components to be manufactured for the additive manufacturing or 3D printing. Corresponding control commands for controlling the adjusting movement of the extruder 30 and hence for controlling one or more print heads 300 here can be implemented easily in terms of software in an electronic control unit 33 of a conventional 3D printing device 3.

The basic idea of the proposed solution furthermore is realized when instead of a power-operated adjustment of the print head 300 relative to the printing platform P (and hence e.g. relative to a print bed) a power-operated adjustment of the printing platform P relative to the print head 300 is effected. Moreover, the proposed solution is not limited to the application on the basis of a Cartesian coordinate system. For example, a (printing) axis along which the deployment of the printing material is effected, and hence a printing path, can also have a curved course. In particular, this can be based on a polar coordinate system. A printing path thus for example can also extend along a circular line and hence along a curved (printing) axis.

The printing material used for manufacturing the outer contour and/or a filling region can include a plastic material, a metal or a ceramic as a constituent. In particular, metal, ceramic and/or plastic granulates can be supplied to the extruder 30 of the 3D printing device 3. Alternatively, for example, a manufacture with a filament or through Wire Arc Additive Manufacturing (WAAM) is possible.

### LIST OF REFERENCE NUMERALS

1.1-1.5, 2.1-2.5 component
2.5a, 2.5b, 2.5c component section
3 3D printing device
30 printing unit/extruder
300 print head
31 adjustment assembly
32 material feeder
33 control unit
d distance
F filling region
K outer contour
L gap
N_{B} number of paths
N_{X} number of components per row
NY number of rows
P printing platform
r radius
R1-R5 component row
S_{B} width
S_{T} gap width

1. A method for the additive manufacturing of multiple components by utilizing at least one print head of a 3D printing device wherein the components are manufactured layer by layer and successively along an axis on a printing platform, wherein
in a layer plane for each of the components succeeding each other along the axis an outer contour initially is manufactured via the at least one print head, which borders a filling region for the respective component, and
subsequently the at least one print head is adjusted along the axis in order to introduce printing material into the filling regions of the multiple components successively along a first printing path, before the print head again is adjusted along the axis in order to introduce printing material into the filling regions of the multiple components successively along a second printing path offset from the first printing path.

2. The method according to claim 1, wherein the at least one print head is adjusted along the axis during the adjustment along the first printing path in a first adjustment direction, and during an adjustment along the second printing path the print head is adjusted in a second adjustment direction opposite to the first adjustment direction along the printing axis.

3. The method according to claim 2, wherein printing material is introduced into the filling regions of the multiple components in a layer plane by moving the print head to and from along mutually offset, parallel printing paths over all outer contours each for the components to be manufactured one beside the other along the axis.

4. The method according to claim 1, wherein the multiple components are arranged along the axis in a row and printing material is introduced into the filling regions of the components of the row along the first printing path, before a further introduction of printing material into the filling regions of the components of the same row is effected along the second printing path.

5. The method according to claim 1, wherein the components are separated from each other along the axis by a gap each and during an adjusting movement of the print head along a printing path, in which printing material is introduced into the filling regions of the multiple components, the deployment of printing material from the print head is stopped on crossing of the gap.

6. The method according to claim 5, wherein the print head forms part of an extruder of the 3D printing device with a rotatable extruder screw, via which printing material is conveyed to the print head, and a width of a gap between the components each is dimensioned such that the deployment of printing material can be stopped by stopping the extruder screw, when the gap is crossed.

7. The method according to claim 1, wherein the multiple components are arranged along the axis in a row and several rows of components or several rows of component sections separated from each other at least in a layer plane are manufactured on the printing platform.

8. The method according to claim 1, wherein via printing material introduced into a respective filling region, at least one of the filling region is at least partly filled with printing material and/or within the filling region at least one inner wall, in particular a lattice structure is formed.

9. The method according to claim 1, wherein the components to be manufactured along the axis are identical or different.

10. The method according to claim 1, wherein at least one constituent of the printing material used for manufacturing at least one outer contour or of printing material used for introduction into at least one filling region is a plastic material, a metal or a ceramic.

11. A 3D printing device for the additive manufacturing of multiple components on a printing platform of the 3D printing device wherein for building up the components layer by layer the 3D printing device comprises at least one extruder with at least one print head for the deployment of printing material and at least one electronic control unit controlling the extruder with at least one processor and at least one memory, wherein the at least one memory contains commands which on execution by the at least one processor cause the extruder, during the additive manufacturing
to initially manufacture in a layer plane for each of the components succeeding each other along the axis an outer contour via the at least one print head which borders a filling region for the respective component and
to subsequently adjust the at least one print head along the axis in such a way that printing material is successively introduced into the filling regions of the multiple components along a first printing path, before the print head again is adjusted along the printing axis in order to introduce printing material into the filling regions of the multiple components successively along a second printing path offset from the first printing path.
